(19) United States
(12) Patent Application Publication
(10) Pub. No.: US 2013/0099055 A1
(43) Pub. Date: Apr. 25, 2013

(54) INTEGRATED LAVATORY PAN FOR COMMERCIAL AIRCRAFT

(71) Applicant: Schneller, Inc., Kent, OH (US)

(72) Inventor: Jacob Thomas PFEIFFER, Hudson, FL (US)

(73) Assignee: SCHNELLER, INC., Kent, OH (US)

(21) Appl. No.: 13/659,085

(22) Filed: Oct. 24, 2012

Related U.S. Application Data
(60) Provisional application No. 61/550,498, filed on Oct. 24, 2011.

(51) Int. Cl. B64C 1/18; B64D 11/02

(52) U.S. Cl. CPC B64C 1/18; B64D 11/02
USPC 244/118.5

(57) ABSTRACT

Aircraft flooring construction wherein the floor covering (e.g. over the floor structure of the aircraft) is an integrated single construction of material or materials with suitable physical properties including moisture impermeability, wear resistance and low combustion and toxicity, for long term and safe use in aircraft and particularly for aircraft lavatory.

### RELATED APPLICATIONS

This application claims priority to U.S. Provisional Patent Application No. 61/550,498, filed on Oct. 24, 2011, a copy of which is incorporated herein by reference in its entirety.

### FIELD OF THE INVENTION

The present disclosure and related inventions pertain generally to aircraft construction and materials and more particularly to flooring materials and construction for aircraft interiors including lavatories and galleys.

### BACKGROUND OF THE INVENTION

Aircraft flooring construction in areas which have to withstand moisture and fluids such as lavatories and galleys or cargo bays, have been constructed with an underlying tray or pan, over which is applied a top layer flooring material such as a polymer or rubber layer, which may or may not be bonded to the underlying tray or pan. This type of construction is susceptible to concentration of moisture or fluid between the tray or pan and the overlying material when there is a failure of the bond of the overlying material. For example in aircraft lavatories there can accumulate a concentration of odorous fluids under the overlying layer, which then requires removal and replacement of the overlying layer. The use of edge sealant has a poor appearance and eventually fails and allows moisture underneath the floor.

### SUMMARY OF THE INVENTION

The present disclosure and related inventions provides an improved aircraft flooring construction wherein the floor covering (e.g. over the floor structure of the aircraft) is an integrated single construction of material or materials with suitable physical properties, such as wear resistance and low combustion and toxicity, for long term and safe use in aircraft.

### DESCRIPTION OF THE DRAWINGS

FIG. 1 is a perspective view of an aircraft lavatory;

FIG. 2 is a perspective view of an integrated lavatory floor pan of the present disclosure.

### DETAILED DESCRIPTION OF THE INVENTION

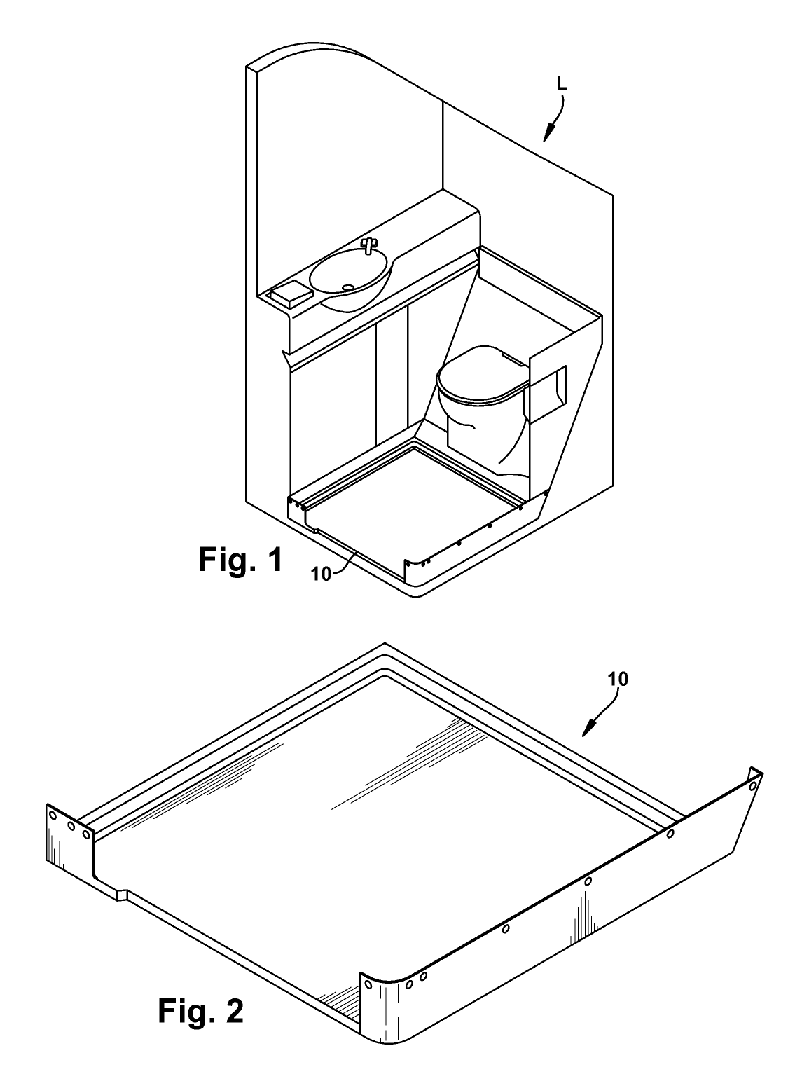

A representative embodiment of an integrated floor product of the present disclosure, adaptable for use in an aircraft lavatory L, as shown for example in FIG. 1, is comprised of a one-piece unit 10 preferably made from a thermoformable combination of a ABS/PVC layered sheet with a decorative PVC cap. The one-piece thermoformable floor unit 10 (also referred to herein as a “lavatory floor pan 10” and “floor”) can be formed into the configuration of a lavatory floor pan 10 and installed directly into an aircraft lavatory L in a manner wherein there is no possibility of transfer of fluid from a top surface of the floor to a bottom surface of the floor. In addition to the noted advantages, the one-piece thermoformed floor unit 10 when formed in the configuration of a lavatory floor pan 10 can be made substantially lighter than the prior two-piece construction (having a decorative flooring material bonded to an underlying pan). Installation time and complexity is also reduced by elimination of the multiple steps of installing an underlying pan and then applying a decorative cover or cap.

One exemplary embodiment of the invention, a one-piece thermoformable lavatory floor pan 10 configured for use in aircraft interiors with moisture and liquid present, includes one or more layers of ABS, such as for example seven (7) layers of 0.15 inch fire retardant press laminated ABS/PVC layered sheet and a 0.16 inch cap layer, such as a clear PVC cap as a cast film which may have a screen print or roll print.

Other exemplary constructions of the lavatory floor pan 10 of the disclosure are set forth below.
I. Cap layer

Texture High haze release film

0.016 clear PVC

print

Base layer

7 layers of 0.15 black 6800 ABS

Blue paper

II. Cap layer

Texture

High haze release film

0.016 clear PVC

Screen print

Base layer

2 layers of LHX

7 layers of ABS

Blue paper

These integrated floor structures for the lavatory floor pan 10 can be manufactured utilizing standard thermo-forming techniques.
Integrated floor constructions of this type exhibit the following in a 12 second vertical burn test:

| 12 sec VB | Ext time | Burn length |
|---|---|---|
| 1. | 0 | .200 in. |
| 2. | 0 | .300 in. |
| 3. | 0 | .200 in. |
| Avg. | 0 | .233 in. |

The lavatory floor pan 10 can be formed in any configuration for any aircraft lavatory or galley dimensions and shape, by thermoforming by use of male and female mold components.
An exemplary embodiment of the floor product and method of manufacture of the disclosure and related inventions includes a print layer, preferably with a clear cap, e.g. 0.016 inches in thickness, and 7 layers of 0.015 in thick ABS. The print layer and ABS layers may be color matched or otherwise coordinated. Using a mold in the form of an aircraft floor covering, or in the form of an existing “lavatory pan”, the composite layers are thermo-formed into a one-piece or integrated lavatory pan. The lavatory floor pan 10 thus created has acceptable frictional properties (i.e., slip resistance) and resistance to burning, as tested for example by a 12 second vertical burn test. One embodiment has a sheet size of the combined materials of 48 inches by 96 inches. Thermo-forming temperature in an approximate range of 335F to 365F, preferably applied to the back or underside in order to retain texture. The combined materials are dried prior to thermo-forming for a period of 16 hours at 155F. Female thermo-forming tooling may be used to retain surface gloss and texture. Grit may be added for altered frictional properties.

1. An integrated single piece lavatory floor pan configured for installation in an aircraft lavatory to substantially cover an entire floor surface thereof, the single piece lavatory floor pan comprising:
a base layer comprising one or more layers of ABS/PVC;
a decorative cap layer located above the base layer, the decorative cap layer made of PVC.

2. The integrated single piece lavatory floor pan of claim 1 comprising at least seven (7) layers of ABS/PVC in the base layer.

3. The integrated single piece lavatory floor pan of claim 2, wherein each of the seven layers of ABS/PVC is at least 0.15-inches thick.

4. The integrated single piece lavatory floor pan of claim 2, wherein each of the seven layers of ABS/PVC is press laminated.

5. The integrated single piece lavatory floor pan of claim 1, wherein the base layer is comprised of fire retardant material.

6. The integrated single piece lavatory floor pan of claim 1, wherein the cap layer has a thickness dimension of at least 0.16-inch.

7. The integrated single piece lavatory floor pan of claim 1, wherein the cap layer is screen printed.

8. The integrated single piece lavatory floor pan of claim 1, wherein the cap layer is substantially clear.

9. An integrated single piece floor comprising:
a base layer made of LHX and ABS;
a cap layer made of PVC;
wherein the integrated single piece floor is suitable for use in an aircraft lavatory.

10. The integrated single piece floor of claim 9, wherein the cap layer is 0.016-inch thick

11. The integrated single piece floor of claim 9, wherein the cap layer includes high haze release film.

12. The integrated single piece floor of claim 9, wherein the cap layer is screen printed.

13. The integrated single piece floor of claim 9, wherein the base layer contains 2 layers of LHX.

14. The integrated single piece floor of claim 9, wherein the base layer contains 7 layers of ABS.

15. The integrated single piece floor of claim 13, wherein the base layer contains 7 layers of ABS.

16. The integrated single piece floor of claim 14, wherein the base and cap layers are thermo-formed into an integrated lavatory pan.

17. An integrated single piece floor suitable for use in an aircraft lavatory, the integrated single piece floor comprising a base of one or more layers of ABS/PVC and a PVC cap formed by a thermo-forming process.

18. The integrated single piece floor of claim 17, wherein the average burn length of the integrated single piece floor in a 12-second vertical burn test is 0.233 inches.

19. The integrated single piece floor of claim 17, wherein the base contains seven layers of ABS/PVC.

20. The integrated single piece floor of claim 17, wherein each layer of ABS/PVC is 0.015-inch thick.
